(19) United States
(12) Patent Application Publication
(10) Pub. No.: US 2025/0121854 A1
(43) Pub. Date: Apr. 17, 2025

(54) VEHICLE SUPERVISION DEVICE AND VEHICLE SUPERVISION SYSTEM

(71) Applicant: Mitsubishi Electric Corporation, Tokyo (JP)

(72) Inventors: Tetsuro NISHIOKA, Tokyo (JP); Keisuke MORITA, Tokyo (JP); Takuya TANIGUCHI, Tokyo (JP)

(73) Assignee: Mitsubishi Electric Corporation, Tokyo (JP)

(21) Appl. No.: 18/895,497

(22) Filed: Sep. 25, 2024

(30) Foreign Application Priority Data
Oct. 16, 2023 (JP) 2023-178014

(51) Int. Cl. B60W 60/00; B60W 30/09; B60W 30/095; G08G 1/01; G08G 1/16

(52) U.S. Cl. CPC B60W 60/0015; B60W 30/09; B60W 30/0953; B60W 30/0956; G08G 1/0112; G08G 1/0116; G08G 1/164

(57) ABSTRACT

An object herein is to prevent a congestion situation from being deteriorated due to intrusion of an autonomous driving vehicle into the congested area, to thereby make more efficient the logistics utilizing autonomous driving vehicles while controlling them. A vehicle supervision device includes: communication unit; an obstacle identification unit that acquires obstacle information externally through the communication unit, to thereby individually identify autonomous driving vehicles and obstacles other than these vehicles; a congestion degree evaluation unit that evaluates a congestion degree per each area; and a driving instruction unit that, when there is the autonomous driving vehicle that is going to enter the area evaluated to be congested, sends to that autonomous driving vehicle, an instruction for causing the vehicle to avoid entering that area. Further, a vehicle supervision system includes: the vehicle supervision device; an autonomous driving control device; and a roadside monitoring device.

### TECHNICAL FIELD

The present disclosure relates to a vehicle supervision device and a vehicle supervision system.

### BACKGROUND

Recently, it is desired to introduce autonomous driving technology to transport vehicles. Because of situations, such as, lack of drivers, labor-cost saving, etc. in transport services, many autonomous transport vehicles have been proposed that utilize autonomous driving vehicles in the yard of a factory and the site of a large-scale commercial facility. For such autonomous transport vehicles, substantive experiments and commercial operations have begun to be performed.

There has been proposed a yard tractor (yard truck) that travels automatically in the yard of a factory to thereby transfer goods between buildings in the factory, and that can automatically connect/disconnect thereto/therefrom a trailer to be towed.

When a plurality of such yard tractors is controlled concurrently, it is possible to achieve in-factory logistics with a small number of workers (see, for example, Patent Document 1).

### CITATION LIST

### Patent Document

Patent Document 1: International Patent Application Publication No. 2019/165147

In the autonomous driving technology for yard tractors described in Patent Document 1, no consideration is given to a case where, with respect to the yard tractors driven automatically, the number of the tractors traveling in a common area increases. Such a situation may arise where a site is congested with the tractors to cause a traffic jam therein and thus, the tractors cannot move freely. In such a congestion situation, it is required that an operator who manages the in-yard logistics instruct, at an adequate timing, each of these yard tractors to move. However, in order for the operator to so instruct them, high-level judgement is required. The result thereby is largely dependent on personal characteristics such as an empirical value, an ability, etc., of the operator. There are cases where a judgment and an operation by a less-experienced operator result in deterioration of the congestion situation and delay of the arrival completion time of goods towed by the yard tractor.

### SUMMARY

An object of the present disclosure is to provide a vehicle supervision device and a vehicle supervision system which can prevent the congestion situation from being deteriorated due to intrusion of the autonomous driving vehicle into the congested area, to thereby make more efficient the logistics utilizing autonomous driving vehicles.

### Solution to Problem

A vehicle supervision device according to this disclosure comprises:
a communication unit that communicates externally;
an obstacle identification unit that acquires obstacle information generated by a plurality of externally-provided obstacle detection units, through the communication unit, to thereby individually identify autonomous driving vehicles and obstacles other than these vehicles;
a congestion degree evaluation unit that evaluates a congestion degree per each area on a basis of information identified by the obstacle identification unit; and
a driving instruction unit that determines whether or not there is the autonomous driving vehicle that is going to enter the area evaluated to be congested by the congestion degree evaluation unit, to thereby, when there is the autonomous driving vehicle that is going to enter said area, send to said autonomous driving vehicle, an instruction for causing that vehicle to avoid entering said area, through the communication unit.

Further, a vehicle supervision system according to this disclosure comprises:
the above vehicle supervision device;
an autonomous driving control device that is mounted on each of the autonomous driving vehicles, that has the obstacle detection unit and that communicates with the vehicle supervision device through an in-vehicle communication unit; and
a roadside monitoring device that has the obstacle detection unit and that communicates with the vehicle supervision device through a roadside communication unit.

### Advantageous Effects

By the vehicle supervision device and the vehicle supervision system according to this disclosure, it is possible to prevent the congestion situation from being deteriorated due to intrusion of the autonomous driving vehicle into the congested area, to thereby make more efficient the logistics utilizing autonomous driving vehicles.

### BRIEF DESCRIPTION OF DRAWINGS

FIG. 1 is a configuration diagram of a vehicle supervision system according to Embodiment 1.

FIG. 2 is a configuration diagram of a vehicle supervision device according to Embodiment 1.

FIG. 3 is a configuration diagram of an autonomous driving control device according to Embodiment 1.

FIG. 4 is a configuration diagram of an auxiliary driving control device according to Embodiment 1.

FIG. 5 is a configuration diagram of a r roadside monitoring device according to Embodiment 1.

FIG. 6 is a hardware configuration diagram of a control device according to Embodiment 1.

FIG. 7 is a block diagram showing a flow of obstacle information to the vehicle supervision device according to Embodiment 1.

FIG. 8 is a diagram showing an obstacle time-series map of the vehicle supervision device according to Embodiment 1.

FIG. 9 is a flowchart showing processing of the vehicle supervision device according to Embodiment 1.

FIG. 10 is a configuration diagram of a vehicle supervision device according to Embodiment 2.

FIG. 11 is a first flowchart showing processing of the vehicle supervision device according to Embodiment 2.

FIG. 12 is a second flowchart showing processing of the vehicle supervision device according to Embodiment 2.

FIG. 13 is a configuration diagram of a vehicle supervision device according to Embodiment 3.

FIG. 14 is a first flowchart showing processing of the vehicle supervision device according to Embodiment 3.

FIG. 15 is a time chart showing processing of the vehicle supervision device according to Embodiment 3.

### DESCRIPTION OF EMBODIMENTS

Hereinafter, embodiments will be described in detail with reference to figures. It should be noted that the figures are schematic/summarized illustrations in which omissions and simplifications are made as appropriate in the configuration elements, for convenience' sake of explanation. Further, a mutual relationship in size and in position between respective configuration elements shown in each of the different figures is not necessarily illustrated precisely, and may be changed as appropriate. Further, in the following description, the same reference numerals will be assigned to equivalent configuration elements as indicated in the figures, and the names and the functions of these elements are assumed to be the same. Accordingly, detailed description may be omitted for such an element in order to avoid duplicated description thereof.

### 1. Embodiment 1

### <Configuration of Vehicle Supervision System>

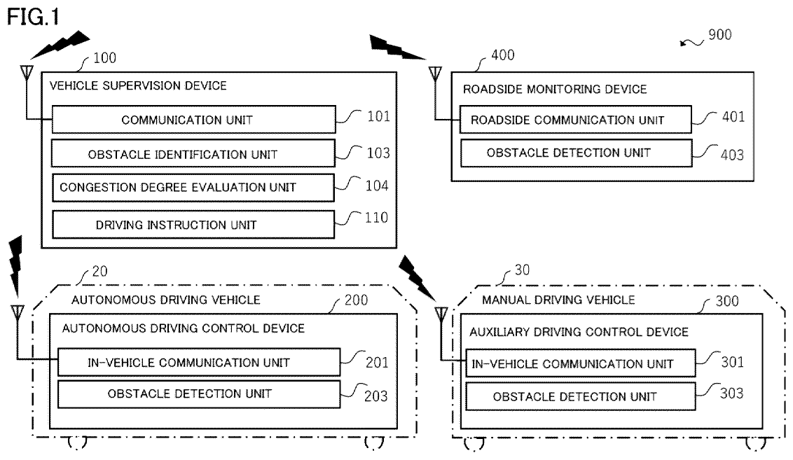

FIG. 1 is a configuration diagram of a vehicle supervision system 900 according to Embodiment 1. The vehicle supervision system 900 is configured in such a manner that a vehicle supervision device 100, an autonomous driving control device 200 that controls an autonomous driving vehicle 20, and a roadside monitoring device 400, are connected by communication to each other. As the communications between the respective devices, wireless communications may be used. Wired communications may used between the vehicle supervision device 100 and the roadside monitoring device 400. In general, the vehicle supervision system 900 is configured to include respective autonomous driving control devices 200 of multiple autonomous driving vehicles 20, and multiple roadside monitoring devices 400. It may be configured to include, in addition to these devices, at least one auxiliary driving control device 300 each controlling a manual driving vehicle 30 provided with a communication function.

Further, the vehicle supervision system 900 may be assumed as a system that includes the vehicle supervision device 100, the autonomous driving vehicle 20 and the manual driving vehicle 30. The vehicle supervision system 900 is a system for preventing the congestion situation from being deteriorated due to intrusion of the autonomous driving vehicle into the congested area. In FIG. 1, the configuration of each of the devices is roughly shown so that only its parts to be mentioned here are illustrated.

The vehicle supervision device 100 communicates with the autonomous driving control device 200, the auxiliary driving control device 300 and the roadside monitoring device 400 in a region subject to supervision, to thereby collect obstacle information related to obstacles on a road. The obstacle information is generated by an obstacle detection unit 203 included in the autonomous driving control device 200, an obstacle detection unit 303 included in the auxiliary driving control device 300 and an obstacle detection unit 403 included in the roadside monitoring device 400. Then, the obstacle information is transmitted to a communication unit 101 included in the vehicle supervision device 100, by an in-vehicle communication unit 201 included in the autonomous driving control device 200, an in-vehicle communication unit 301 included in the auxiliary driving control device 300 and a roadside communication unit 401 included in the roadside monitoring device 400.

From the obstacle information collected through the communication unit 101, the vehicle supervision device 100 individually identifies, using its obstacle identification unit 103, the autonomous driving vehicles and obstacles other than these vehicles. Then, on the basis of information identified by the obstacle identification unit 103, a congestion degree evaluation unit 104 evaluates a congestion degree per each area resulting from dividing the region subject to supervision.

A driving instruction unit 110 in the vehicle supervision device 100 determines whether or not there is the autonomous driving vehicle 20 that is going to enter the area evaluated to be congested by the congestion degree evaluation unit. Then, when there is the autonomous driving vehicle 20 that is going to enter such congested area, the driving instruction unit sends to said autonomous driving vehicle 20, an instruction for causing that vehicle to avoid entering said area, through the communication unit 101.

As the instruction for causing the autonomous driving vehicle 20 to avoid entering said area, such an instruction is assumed that causes the vehicle to reduce the traveling speed to thereby delay the time of intrusion into said area. Further, such an instruction is assumed that causes the autonomous driving vehicle 20 to stop to wait at a place where the vehicle does not hinder the traffic. If the congestion situation of said area is relieved, the vehicle is allowed to begin intruding into that area. Further, such an instruction is assumed that causes the vehicle to travel up to a destination place or a via place while bypassing said area. If the area is not a via place necessary to be visited, the vehicle can continue traveling by bypassing that area.

The vehicle supervision device 100 can acquire from the autonomous driving control device 200, information such as a current position, a current traveling direction, a current traveling speed, etc. of each of the autonomous driving vehicles 20, to thereby estimate an expected traveling route of the autonomous driving vehicles 20. Further, the vehicle supervision device 100 can also acquire an action plan that the autonomous driving vehicles 20 each have, to thereby recognize the expected traveling route of the autonomous driving vehicle 20. The action plan is a traveling plan under the constraints of traffic rules that is obtained from retrieval of an optimum route for the autonomous driving vehicle 20 to travel from a departure place to a destination place. The action plan that the autonomous driving vehicle 20 has is updated in response to a change in environment therearound.

### <Vehicle Supervision Device>

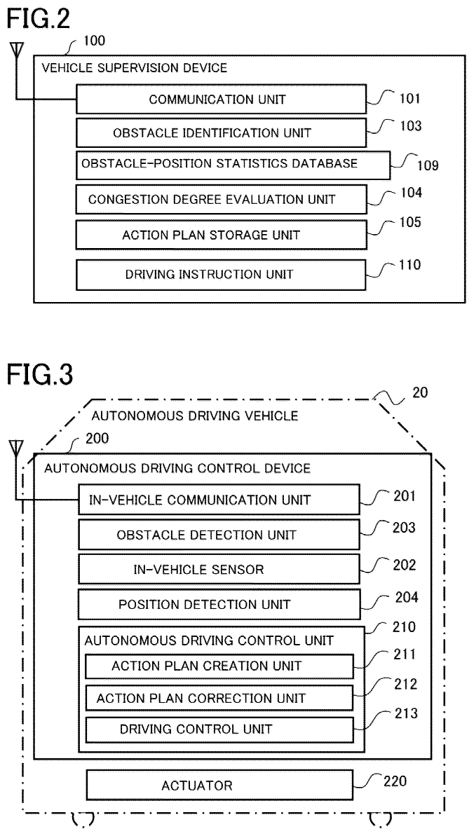

FIG. 2 is a configuration diagram of the vehicle supervision device 100 according to Embodiment 1. The vehicle supervision device 100 receives the obstacle information from the autonomous driving control devices 200, the auxiliary driving control devices 300 and the roadside monitoring devices 400, through the communication unit 101. Further, the vehicle supervision device 100 receives the respective action plans from the autonomous driving control devices 200, through the communication unit 101.

An obstacle-position statistic database 109 of the vehicle supervision device 100 stores the received obstacle information. It is possible to predict a moving status of each of the objects by statistically analyzing the data of the obstacle-position statistics database 109. An occupation time of an obstacle in the future may be estimated from statistics information about the previous occupation area and the previous occupation time.

Further, it is also possible to estimate a detection error of an object and a position of the object in the future, by checking the position, size, shape, moving direction and moving speed of the object detected by the obstacle detection unit on the basis of data of respective sensors included in the respective devices. Furthermore, it is also possible to identify the same obstacle from the obstacle information according to the multiple obstacle detection units.

An action plan storage unit 105 of the vehicle supervision device 100 stores the action plan of each of the autonomous driving vehicles 20 received through the communication unit 101. The action plan storage unit 105 provides in a referable state, the action plans of all of the autonomous driving vehicles subject to supervision.

The obstacle identification unit 103 identifies the current positions of the autonomous driving vehicles 20 and obstacles other than these vehicles and the estimated positions thereof at each time point in the future, from the obstacle information, the information of the obstacle-position statistic database 109 and the action plans of the autonomous driving vehicles 20 stored in the action plan storage unit 105. The obstacle identification unit 103 prepares an obstacle time-series map in which the region subject to supervision is divided into given areas and the congestion degree per each area is stated for each time point.

The congestion degree evaluation unit 104 evaluates the congestion degree per each area at each time point that is made clear by the obstacle time-series map. The congestion degree may be represented by the number of obstacles or the number of the vehicles per each area. The congestion degree of any given area (n, m) may be defined by Dnm (“n” denotes an X-coordinate value, and “m” denotes a Y-coordinate value). The area (n, m) may be evaluated to be congested when the congested degree Dnm of that area (n, m) is equal to or more than a predetermined determinative value DK. In the case of the determinative value DK=1, the area will be evaluated to be congested if there is even one obstacle in that area.

The driving instruction unit 110 determines whether or not there is the autonomous driving vehicle 20 that will enter the area evaluated to be congested by the congestion degree evaluation unit 104. If there is no area evaluated to be congested or there is no autonomous driving vehicle 20 that will enter the area evaluated to be congested, it is assumed that there is no problem, so that no instruction is issued from the driving instruction unit 110.

If there is the autonomous driving vehicle 20 that will enter the area evaluated to be congested, such a situation may be conceivable in which the congestion degree becomes much higher due to entering of the autonomous driving vehicle 20 into the congested area and thus the vehicles are difficult to pass therethrough. In order to avoid such a situation, the driving instruction unit 110 specifies the autonomous driving vehicle 20 that is going to enter the congested area, to thereby give to that vehicle, an instruction for causing the vehicle to avoid entering the congested area. Such an avoidance instruction by the driving instruction unit 110 is sent to that vehicle through the communication unit 101.

### <Autonomous Driving Control Device>

FIG. 3 is a configuration diagram of the autonomous driving control device 200 according to Embodiment 1. The autonomous driving control device 200 is mounted on the autonomous driving vehicle 20 and, by a driving control unit 213 in an autonomous driving control unit 210, an actuator 220 is activated in order to establish autonomous driving. The actuator 220 represents a group of actuators by which operations to accelerate, decelerate, turn and stop the autonomous driving vehicle 20 can be performed. Specifically, autonomous driving can be achieved by operating: a propulsion apparatus such as an internal combustion engine, an electric motor or the like; a transmission apparatus; a brake mechanism and a steering gear.

In order to cause the autonomous driving vehicle 20 to perform autonomous driving, its action plan has to be created according to an instruction from the passenger or from the outside. The action plan is a traveling plan under the constraints of traffic rules that is obtained from retrieval of an optimum route for the autonomous driving vehicle 20 to travel from a departure place to a destination place. When an action-plan objective for determining a departure place, a via place, a destination place and loading/unloading of goods, that are basic elements for creating the action plan, and time restrictions on these elements, is indicated from the passenger or from the outside, an action plan creation unit 211 in the autonomous driving control device 200 creates the action plan.

The autonomous driving control device 200 activates the actuator 220 according to the action plan created by the action plan creation unit 211, to thereby operate the autonomous s driving vehicle 20. Even when an unexpected obstacle appears, the autonomous driving control device 200 can cause the autonomous driving vehicle 20 to continue traveling, while correcting the action plan by using an action plan correction unit 212. The action plan is not a fixed plan but is used while being updated. The autonomous driving control device 200 transmits the created action plan and the corrected action plan to the vehicle supervision device 100 through the in-vehicle communication unit 201, to thereby share these action plans.

The autonomous driving control device 200 includes a position detection unit 204 that detects the position information of the autonomous driving vehicle 20. The position detection unit 204 can calculate the host vehicle position by using: positioning information from a GNSS (Global Navigation Satellite System) for detecting the host vehicle position; a travel distance sensor that detects the wheel rotation number of the autonomous driving vehicle 20; a gyro sensor that detects the acceleration, the speed, the angular acceleration and the angular speed of the autonomous driving vehicle 20; and the like. Further, the host vehicle position may be specified by use of a short-range wireless communication technology, such as an NFC (Near Field Communication) technology that uses information of embedded tags or the like on the road side. Furthermore, the host vehicle position may be determined in such a manner that a building and a sign acting as landmarks are identified by an in-vehicle sensor 202.

The vehicle position information of the autonomous driving vehicle 20 detected by the position detection unit 204 is sent to the autonomous driving control unit 210 and is used for autonomous driving. Further, the vehicle position information is transmitted to the vehicle supervision device 100 through the in-vehicle communication unit 201, and is thus shared.

During traveling of the autonomous driving vehicle 20, the external environment changes constantly. For that reason, the autonomous driving control device 200 finds out an object around the vehicle by using the in-vehicle sensor 202 and detects an obstacle by using the obstacle detection unit 203. The in-vehicle sensor 202 represents a group of sensors for recognizing the external environment, and may be constituted by a combination of an image sensor, a radio sensor, an optical sensor, an ultrasonic sensor, and the like. As the obstacle to be detected, a three or more-wheeled vehicle, a motorcycle, a bicycle, a pedestrian, another obstructive object, or the like, may be assumed.

As represented by a monitoring camera, the image sensor images an object and then calculates from the image data captured within a specified viewing angle, a distance to that object. From the image data, a size, a moving direction, a moving speed, a type or the like, of the object may be acquired. As the image sensor, a visible light camera, an infrared camera or the like may be used.

As the radio sensor, a millimeter wave radiometer radar (MMWR) that uses a frequency range of 24 to 79 GHz, or the like may be used. By the radio sensor, it is possible to detect the position of an object and also to detect, using a Doppler effect, the moving speed of the object.

As the optical sensor, a laser radar, a LiDAR (Light Detection and Ranging) or the like may be used. It is possible to recognize the position and the shape of an object by radiating laser light within a fixed viewing field to thereby detect point-group data obtained due to reflection of the laser light on the object.

The obstacle detection unit 203 receives information of the image sensor, the radio sensor, the optical sensor and the ultrasonic sensor as sensors for recognizing the external environment. As the in-vehicle sensor 202, all of the image sensor, the radio sensor, the optical sensor and the ultrasonic sensor may be used as described above; however, only one or some of these sensors may be used. Further, a sensor other than the above may be used in order to recognize the external environment.

The obstacle detection unit 203 may employ a sensor fusion technique in which an object is detected using the above pieces of information in combination. By combining such plural types of sensor information, it becomes possible to remove noise information to thereby perform ranging, speed detection and an object, highly attributive identification of reliably. Further, an obstacle may be identified on the basis of a reinforcement learning such as deep learning.

These pieces of sensor information may be all processed by the obstacle detection unit 203; however, it is allowed that information processing is executed in each of these sensors, namely, the data acquired by such various sensors is processed there, and then, only identified information of a position, an outer shape, a speed and a type about the identified object, is sent to the obstacle detection unit 203. This makes it possible to execute processing of the sensor information in a distributed manner, so that an amount of information to be processed solely by the obstacle detection unit 203 can be reduced.

The obstacle detection unit 203 sends the obstacle information as information related to the obstacle, to the autonomous driving control unit 210. The autonomous driving control unit 210, whenever necessary, corrects the action plan by using the action plan correction unit 212. Further, the obstacle detection unit 203 transmits the obstacle information to the vehicle supervision device 100 through the in-vehicle communication unit 201.

### <Auxiliary Driving Control Device>

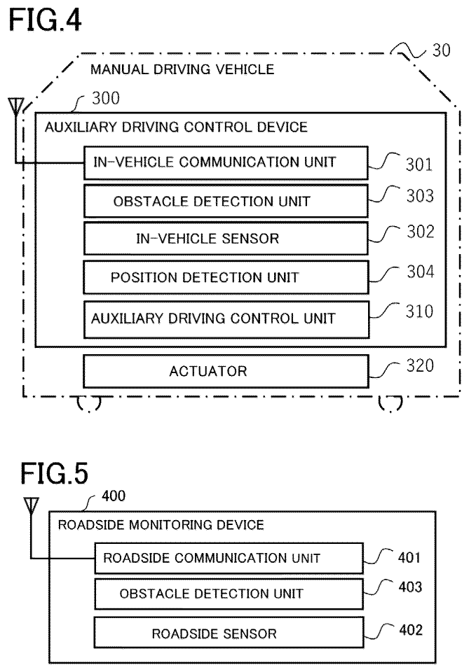

FIG. 4 is a configuration diagram of the auxiliary driving control device 300 according to Embodiment 1. As the auxiliary driving control device 300, such a control device for the manual driving vehicle 30 is assumed that introduces techniques of: collision damage reduction braking (Autonomous Emergency Braking (AEB)) in which an obstacle located on the front side, rear side or lateral side of a vehicle is detected to thereby bring the vehicle to an emergency stop; an active cruise control device that causes a vehicle to travel following a vehicle ahead; a lane keeping device that performs steering while keeping the traffic lane; and the like.

Like the autonomous driving vehicle 20, the manual driving vehicle 30 includes an in-vehicle sensor 302. The obstacle detection unit 303 generates the obstacle information from the signals of the in-vehicle sensor 302, and sends it to an auxiliary driving control unit 310. The auxiliary driving control unit 310 serves for the control of AEB or the like, by activating an actuator 320. The obstacle detection unit 303 transmits the obstacle information to the vehicle supervision device 100 through the in-vehicle communication unit 301, to thereby share that information.

Unlike the autonomous driving control device 200 of the autonomous driving vehicle 20, the auxiliary driving control device 300 of the manual driving vehicle 30 has no action plan. Thus, it is not possible to transmit an action plan to the vehicle supervision device 100 to thereby share a future traveling route of that vehicle. However, the vehicle position information of the manual driving vehicle 30 detected by a position detection unit 304 is transmitted to the vehicle supervision device 100 through the in-vehicle communication unit 301, and is thus shared. Note that description of a manual driving vehicle without a communication function is omitted here.

### <Roadside Monitoring Device>

FIG. 5 is a configuration diagram of the roadside monitoring device 400 according to Embodiment 1. The roadside monitoring device 400 may also be referred to as an RSU (Road Side Unit). On the road side, multiple roadside monitoring devices 400 are placed which each include a roadside sensor 402 that detects an obstacle therearound. The multiple roadside monitoring devices 400 may be located collectively at the same place so as to perform monitoring in all directions around them in a shared manner. Instead, the multiple roadside monitoring devices 400 may be located apart from each other so as to monitor a road, an intersection, etc. from different directions. In terms of cost, etc., it is impractical to detect the obstacles on all of the roads, so that, in many cases, the roadside monitoring devices 400 are placed, in particular, at an intersection/corner with heavy traffic, a road with poor visibility, and the like.

Using the roadside sensor 402, the roadside monitoring device 400 recognizes an external environment within a specified viewing angle, to thereby detect an obstacle around an intersection or a road. As the sensor that recognizes the external environment, like the in-vehicle sensors 202, 302, an image sensor, a radio sensor, an optical sensor, an ultrasonic sensor and the like may be included. As the obstacle to be detected, like the cases of the in-vehicle sensors 202, 302, a three or more-wheeled vehicle, a motorcycle, a bicycle, a pedestrian, another obstructive object, or the like, may be assumed.

Further, although the roadside monitoring device 400 may use all of the image sensor, the radio sensor, the optical sensor and the ultrasonic sensor as described above, it may use only one or some of these sensors. Further, a sensor other than the above may be used in order to recognize the external environment.

The obstacle detection unit 403 may employ a sensor fusion technique in which an object is detected using the above pieces of information in combination. Such pieces of sensor information may be all processed by the obstacle detection unit 403. However, it is allowed that information processing is executed in each of these sensors, namely, the data acquired by such various sensors is processed there, and then, only information of a position, an outer shape, a speed and a type about the identified object, is sent to the obstacle detection unit 403.

This makes it possible to execute processing of the sensor information in a distributed manner, so that an amount of information to be processed solely by the obstacle detection unit 403 can be reduced. The obstacle information around the roadside monitoring device 400 generated from the signals of the roadside sensor 402 by the obstacle detection unit 403, is transmitted to the vehicle supervision device 100 through the roadside communication unit 401, and is thus shared.

### <Hardware Configuration of Control Device>

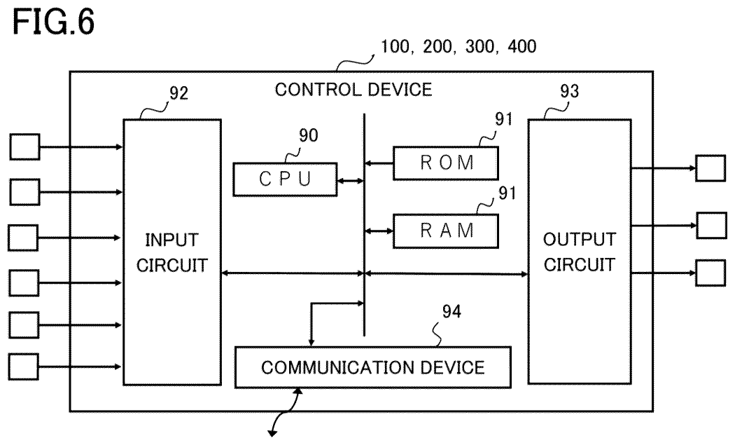

FIG. 6 is a hardware configuration diagram of a control device. The hardware configuration shown in FIG. 6 may be applied to each of the vehicle supervision device 100, the autonomous driving control device 200, the auxiliary driving control device 300 and the roadside monitoring device 400. Here, description will be made about a case where it is applied to the vehicle supervision device 100 as a representative. In this Embodiment, the vehicle supervision device 100 is an electronic control device which is provided for supervising the autonomous driving vehicles 20. The respective functions of the vehicle supervision device 100 are implemented by a processing circuit included in the vehicle supervision device 100. Specifically, the vehicle supervision device 100 includes as the processing circuit: an arithmetic processing device 90 (computer) such as a CPU (Central Processing Unit) or the like; storage devices that perform data transactions with the arithmetic processing device 90; an input circuit 92 that inputs external signals to the arithmetic processing device 90; an output circuit 93 that externally outputs signals from the arithmetic processing device 90; and the like. The respective pieces of hardware, such as the arithmetic processing device 90, the storage devices 91, the input circuit 92, the output circuit 93, etc. are connected to each other by way of a wired network such as a bus line, or a wireless network.

As the arithmetic processing device 90, there may be included an ASIC (Application Specific Integrated Circuit), an IC (Integrated Circuit), a DSP (Digital Signal Processor), a GPU (Graphics Processing Unit), an FPGA (Field Programmable Gate Array), any one of a variety of logic circuits, any one of a variety of signal processing circuits, or the like. Further, multiple arithmetic processing devices 90 of the same type or different types may be included so that the respective parts of processing are executed in a shared manner. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. As the storage device 91, a non-volatile or volatile semiconductor memory, such as a flash memory, an SSD (Solid State Drive), an EPROM, an EEPROM or the like; a magnetic disc; a flexible disc; an optical disc; a compact disc; a mini disc; a DVD; or the like, may be used. The input circuit 92 includes A-D converters, a communication circuit, etc. to which a variety of sensors and switches and a communication line, are connected, and which serve to input the output signals of the sensors and switches, and communication information, to the arithmetic processing device 90. The output circuit 93 includes a driver circuit, a communication circuit, etc. which serve to output control signals coming from the arithmetic processing device 90. The interfaces of the input circuit 92 and the output circuit 93 may be those based on the specification of CAN (Control Area Network) (Registered Trademark), Ethernet (Registered Trademark), USB (Universal Serial Bus) (Registered Trademark), DVI (Digital Visual Interface) (Registered Trademark), HDMI (High-Definition Multimedia Interface) (Registered Trademark) or the like. Further, independently of the input circuit 92 and the output circuit 93, it is allowed to establish communications by directly connecting the arithmetic processing device 90 to a communication device 94.

The respective functions that the vehicle supervision device 100 includes, are implemented in such a manner that the arithmetic processing device 90 executes software (programs) stored in the storage device 91 such as the ROM or the like, to thereby cooperate with the other hardware in the vehicle supervision device 100, such as the other storage device 91, the input circuit 92, the output circuit 93, etc. Note that the set data of threshold values, determination values, etc. to be used by the vehicle supervision device 100 is stored, as a part of the software (programs), in the storage device 91 such as the ROM or the like. Although each of the functions that the vehicle supervision device 100 has, may be established by a software module, it may be established by a combination of software and hardware.

### <Flow of Obstacle Information>

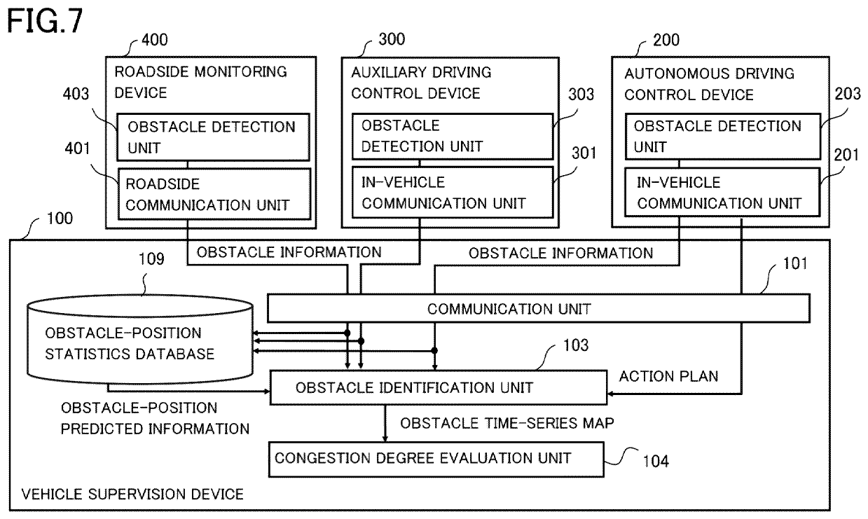

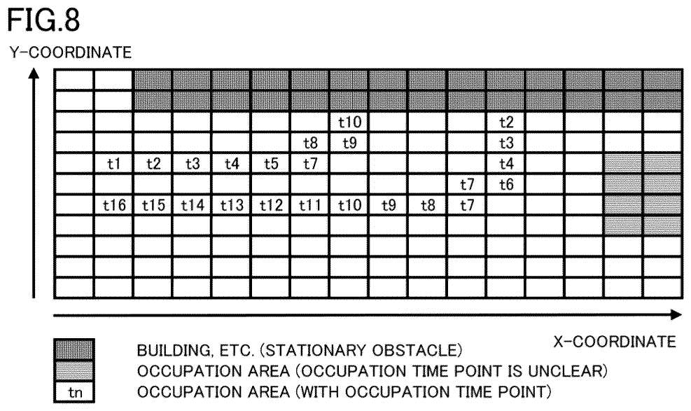

FIG. 7 is a block diagram showing a flow of obstacle information to the vehicle supervision device 100 according to Embodiment 1. FIG. 8 is a diagram showing an obstacle time-series map of the vehicle supervision device 100 according to Embodiment 1.

Illustrated in FIG. 7 is how obstacle information generated by each of the obstacle detection unit 203 in the autonomous driving control device 200, the obstacle detection unit 303 in the auxiliary driving control device 300 and the obstacle detection unit 403 in the roadside monitoring device 400, is transmitted to the vehicle supervision device 100 through each of the communication units in these devices. Then, the respective pieces of obstacle information are sent through the communication unit 101 of the vehicle supervision device 100, to the obstacle identification unit 103 and the obstacle-position statistic database 109.

The data stored in the obstacle-position statistic database 109 is statistically processed, so that future-position predicted information of obstacles other than the autonomous driving vehicles 20 is sent to the obstacle identification unit 103. Further, from the autonomous driving control device 200, the action plans of the autonomous driving vehicles 20 are sent to the obstacle identification unit 103. On the basis of these pieces of information, the obstacle identification unit 103 can prepare the obstacle time-series map in which an occupation area of an obstacle at each corresponding time point is shown.

As shown in FIG. 8, the obstacle time-series map shows how any given area is occupied by an obstacle, in a time-series manner. In FIG. 8, each occupation time point of an obstacle (t1 to t16) is stated per each area. Here, whether or not there is an occupation time point of an obstacle, is stated per each area. Further, a stationary obstacle (fixed obstacle) such as a building or the like is indicated in such a manner that s corresponding area is filled with mesh lines. Further, an obstacle whose occupation time point is unclear is indicated in such a manner that its corresponding area is filled with horizontal striped lines.

By preparing the obstacle time-series map, it is possible, using the congestion degree evaluation unit 104, to determine the congested area. In FIG. 8, each area that is expected to be occupied by an obstacle is determined to be a congested area at each corresponding time point. From the action plans, it is checked whether or not there is the autonomous driving vehicle 20 that will enter such a congested area.

With respect to the autonomous driving vehicle 20 that will enter the above area at a time point at which the obstacle is present, an instruction that causes the vehicle to avoid such entering is transmitted thereto from the vehicle supervision device 100. Upon receiving the instruction for avoiding such entering, the autonomous driving control device 200 causes the vehicle to stop to wait, or to travel while bypassing that area, so that it is possible to prevent the congestion situation from being deteriorated. Further, since the traffic stagnation due to congestion is eliminated, it is possible to make more efficient the logistics as a whole.

It is further noted that an obstacle time-series map that is different from the obstacle time-series map exemplified in FIG. 8 may instead be used. For example, such an obstacle time-series map may be used in which the name (discrimination ID) of an obstacle is stated with its occupation time point per each corresponding area, to thereby show how the plural types of obstacles occupy the areas. Further, the congestion degree may be represented by the number of concurrently present obstacles or vehicles per each area. The congestion degree of any given area (n, m) at any given time point (“n” denotes an X-coordinate value, and “m” denotes a Y-coordinate value) may be defined by Dnm. The area (n, m) may be evaluated to be congested when the congested degree Dnm of that area (n, m) is equal to or more than a predetermined determinative value DK.

### <Processing of Vehicle Supervision Device>

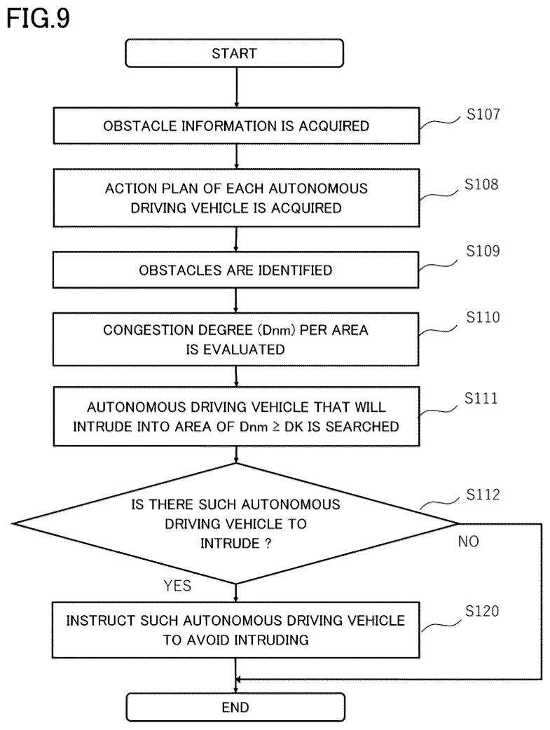

FIG. 9 is a flowchart showing processing of the vehicle supervision device 100 according to Embodiment 1. The processing shown in FIG. 9 is executed by the arithmetic processing device in the vehicle supervision device 100. The processing may be executed every fixed period of time (for example, every 1 ms). It is allowed that the processing is not executed every fixed period of time but executed in response to an event, for example, in response to the reception of the obstacle information generated by the obstacle detection units of the autonomous driving control device 200, the auxiliary driving control device 300 and the roadside monitoring device 400, by the communication unit 101 in the vehicle supervision device 100, or in response to the reception of the action plan from the autonomous driving control device 200 by that communication unit.

Upon starting the processing of FIG. 9, in Step S107, the vehicle supervision device 100 acquires the obstacle information generated by the obstacle detection units of the autonomous driving control devices 200, the auxiliary driving control devices 300 and the roadside monitoring devices 400. Then, in Step S108, the vehicle supervision device 100 acquires the action plans of the autonomous driving control devices 200.

In Step S109, obstacles are identified. Specifically, from the above information, the obstacle time-series map in which an occupation area of each obstacle at each corresponding time point is shown, is prepared by the obstacle identification unit 103 of the vehicle supervision device 100. Then, in Step S110, based on the obstacle time-series map, the congestion degree is evaluated by the congestion degree evaluation unit 104.

Here, the congestion degree per each area has been calculated as Dnm.

In Step S111, an area whose congestion degree Dnm is equal to or more than the determinative value DK (a congested area) is extracted and then, an autonomous driving vehicle 20 that will enter that area at its corresponding time point is searched. In Step S112, it is determined whether or not there is the autonomous driving vehicle 20 that will so enter that area. If there is the autonomous driving vehicle 20 that will so enter that area (judgment is YES), the flow moves to Step S120. If it is determined that there is no autonomous driving vehicle 20 that will so enter that area (judgment is NO), the processing is terminated.

In Step S120, to the autonomous driving control unit 200 of the corresponding autonomous driving vehicle 20, an instruction for causing that vehicle to avoid such entering is transmitted. Thereafter, the processing is terminated.

In this manner, by the vehicle supervision device 100 and the vehicle supervision system 900 according to Embodiment 1, it is possible to prevent the congestion situation from being deteriorated due to intrusion of the autonomous driving vehicle 20 into the congested area, to thereby make more efficient the logistics utilizing the autonomous driving vehicles 20.

### 2. Embodiment 2

### <Vehicle Supervision Device>

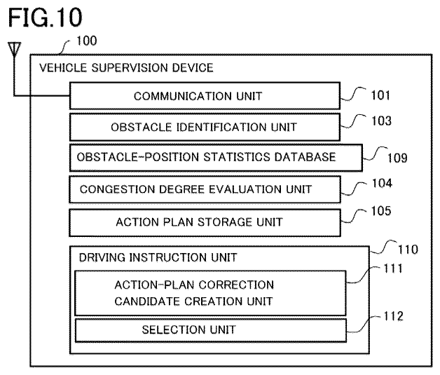

FIG. 10 is a configuration diagram of a vehicle supervision device 100 according to Embodiment 2. In FIG. 10, what differs from FIG. 2 according to Embodiment 1 resides only in that an action-plan correction candidate creation unit 111 and a selection unit 112 are provided in the driving instruction unit 110. Here, description will be made only on differences from Embodiment 1.

In the vehicle supervision device 100 according to Embodiment 2, an obstacle time-series map is prepared in which an occupation area of an obstacle at each corresponding time point is shown, and an area whose congestion degree Dnm is equal to or more than the determinative value DK (a congested area) is extracted, and then an autonomous driving vehicle 20 that will enter that area at its corresponding time point is searched. If there is the autonomous driving vehicle 20 that will enter such congested area, the action-plan correction candidate creation unit 111 creates action-plan correction candidates for that autonomous driving vehicle 20.

Regarding a mass of predefined plans of various actions that may possibly be taken by the autonomous driving vehicle 20 (referred to also as a strategy group), various situations caused by the execution of strategies included in that group are simulated, to thereby predict the respective results due to execution of the actions. The strategy corresponds to how to create the action-plan correction candidates examples of which cause the corresponding autonomous driving vehicle 20 to wait for a fixed interval of time in a specific non-congested area; cause the corresponding autonomous driving vehicle 20 to enter the congested area to keep its action plan without waiting; and cause the corresponding autonomous driving vehicle 20 to travel by bypassing the congested area concerned. Further, as the information to be included in the thus-obtained results, evaluated results (evaluation scores) that are obtained using, for example, the time taken for completion of the action plan of each of the autonomous driving vehicles 20; an occupation area and an occupation time thereof; and a worst value of the congestion degrees in the congested areas; and the like, are assumed.

The selection unit 112 selects an optimum action-plan correction candidate from the action-plan correction candidates created by the action-plan correction candidate creation unit 111. Then, it sends to the autonomous driving control unit 200 of the corresponding autonomous driving vehicle 20, an optimum action-plan correction instruction for causing that vehicle to avoid entering the congested area at its corresponding time point, through the communication unit 101. Here, with respect to an index used in the selection unit 112 for evaluating an action-plan correction candidate to be optimum, such an action-plan that correction candidate makes the action-plan completion time of the corresponding autonomous driving vehicle 20 earliest, may be selected as an optimum action-plan correction candidate. Namely, in that case, such an action-plan correction candidate is selected that makes earliest the time point at which the action plan that satisfies its action-plan objective is completed by that autonomous driving vehicle. Instead, the selection unit 112 may select, as an optimum action-plan correction candidate, such an action-plan correction candidate that makes the maximum value of the congestion degrees in the region subject to supervision smallest. Namely, in that case, the respective congestion degrees of all areas are checked for each of the correction candidates, and the correction candidate that makes the maximum value of the congestion degrees smallest is selected as an optimum action-plan correction candidate.

### <Processing of Vehicle Supervision Device>

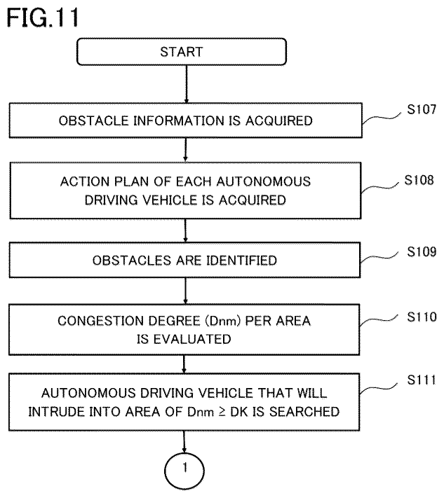

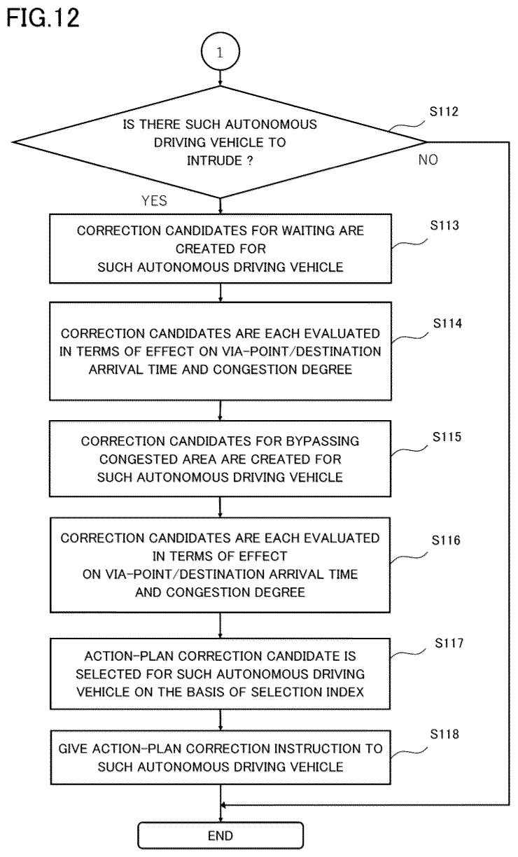

FIG. 11 is a first flowchart showing processing of the vehicle supervision device 100 according to Embodiment 2. FIG. 12 a second flowchart showing processing of the vehicle supervision device 100 according to Embodiment 2. The flowchart of FIG. 12 shows the flow subsequent to the flowchart of FIG. 11.

In the flowcharts of FIG. 11 and FIG. 12 according to Embodiment 2, what differs from the flowchart of FIG. 9 according to Embodiment 1 resides only in that Step S120 in FIG. 9 is replaced with Steps S113 to S118 in FIG. 12. Here, description will be made only on differences from Embodiment 1.

The processing shown in FIG. 11 and FIG. 12 is executed by the arithmetic processing device in the vehicle supervision device 100. The processing may be executed every fixed period of time (for example, every 1 ms). It is allowed that the processing is not executed every fixed period of time but executed in response to an event, for example, in response to the reception of the obstacle information generated by the obstacle detection units of the autonomous driving control device 200, the auxiliary driving control device 300 and the roadside monitoring device 400, by the communication unit 101 in the vehicle supervision device 100, or in response to the reception of the action plan from the autonomous driving control device 200 by that communication unit.

In Step S112 in FIG. 12, an area whose congestion degree Dnm is equal to or more than the determinative value DK (a congested area) is extracted and then, it is determined whether or not there is the autonomous driving vehicle 20 that will enter that area at its corresponding time point. If there is the autonomous driving vehicle 20 that will so enter that area (judgment is YES), the flow moves to Step S113. If it is determined that there is no autonomous driving vehicle 20 that will so enter that area (judgment is NO), the processing is terminated.

In Step S113, out of possible action-plan correction candidates for the corresponding autonomous driving vehicle 20, the action-plan correction candidate creation unit 111 creates the correction candidates for waiting. The correction candidates for waiting are each an action-plan correction candidate for causing the autonomous driving vehicle 20 to wait at a given place until the congestion situation is relieved and an additional action-plan correction instruction is sent to that vehicle. Namely, multiple action-plan correction candidates for waiting which are worth considering, are proposed by the action-plan correction candidate creation unit 111.

In Step S114, the thus-proposed correction candidates are each evaluated using, as an evaluation index, an effect on a via point/destination arrival time and the congestion degree, or the like. Thereafter, in Step S115, out of the possible action-plan correction candidates for the corresponding autonomous driving vehicle 20, the action-plan correction candidate creation unit 111 creates the correction candidates for bypassing the congested area. The correction candidates for bypassing the congested area are each an action-plan correction candidate for causing the vehicle to travel to a destination place or a via place by bypassing the congested area. If that area is not a via place necessary to be visited, the vehicle is allowed to continue traveling by bypassing that area, and is thus advantageous.

In Step S116, the thus-proposed correction candidates are each evaluated using, as an evaluation index, an effect on a via point/destination arrival time and the congestion degree, or the like. In Step S117, on the basis of the index selected, from among the respective correction candidates proposed by the action-plan correction candidate creation unit 111, the correction candidate that has been most highly evaluated is selected.

Then, in Step S118, the selected action-plan correction candidate is sent through the communication unit 101 to the autonomous driving control unit 200 of the corresponding autonomous driving vehicle 20. Thereafter, the processing is terminated. After receiving this correction candidate, the corresponding autonomous driving vehicle 20 will continue autonomous driving control on the basis of the thus-corrected action plan.

With this configuration, the vehicle supervision device 100 and the vehicle supervision system 900 can prevent the congestion situation from being deteriorated due to intrusion of the autonomous driving vehicle 20 into the congested area, and can give a specific instruction to the autonomous driving control device 200 by transmitting the selected action-plan correction candidate to the autonomous driving vehicle 20. This makes it possible to realize an optimum instruction for making more efficient the logistics.

### 3. Embodiment 3

### <Vehicle Supervision Device>

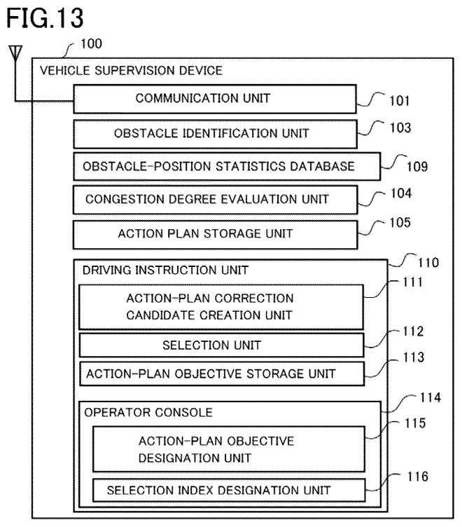

FIG. 13 is a configuration diagram of a vehicle supervision device 100 according to Embodiment 3. In FIG. 13, what differs from FIG. 10 according to Embodiment 2 resides in that an action-plan objective storage unit 113 is added in the driving instruction unit 110, and an operator console 114 having an action-plan objective designation unit 115 and a selection index designation unit 116 is provided in the driving instruction unit 110. Here, description will be made only on differences from Embodiment 2.

In the vehicle supervision device 100 according to Embodiment 3, an action-plan objective designated for each of the autonomous driving vehicles 20 is stored in the action-plan objective storage unit 113 at each time it is designated. This makes it possible to recognize the latest status of the action-plan objective designated for each of the autonomous driving vehicles 20, and to refer thereto when the action-plan correction candidates are created.

In addition, the vehicle supervision device 100 according to Embodiment 3 allows an operator to instruct, using the operator console 114, the autonomous driving control device 200 of a specific autonomous driving vehicle 20 to update its action-plan objective. Further, the operator is allowed to instruct, using the operator console 114, the selection unit to update a selection index for selecting an optimum action-plan correction candidate from the action-plan correction candidates.

Here, the action-plan objective is information for determining: a departure place, a via place, a destination place and loading/unloading of goods, that are basic elements for creating the action plan of each autonomous driving vehicle 20; and time restrictions on these elements. The action plan creation unit 211 of the autonomous driving vehicle 20 creates the action plan on the basis of the action-plan objective. When the operator issues, using the operator console 114 in the vehicle supervision device 100, an instruction for updating the action-plan objective of a specific autonomous driving control device 200, an action-plan objective for updating is sent from the vehicle supervision device 100 to the corresponding autonomous driving control device 200.

The selection index is an index for selecting, in the selection unit 112, an action-plan correction candidate for the autonomous driving vehicle 20. For example, such a case is assumed where, from among the action-plan correction candidates, an action-plan correction candidate that makes the action-plan completion time of the corresponding autonomous driving vehicle 20 earliest is selected as an optimum action-plan correction candidate. Further, such a case is assumed where, from among the action-plan correction candidates, an action-plan correction candidate that makes the maximum value of the congestion degrees smallest is selected as an optimum action-plan correction candidate.

### <Processing of Vehicle Supervision Device>

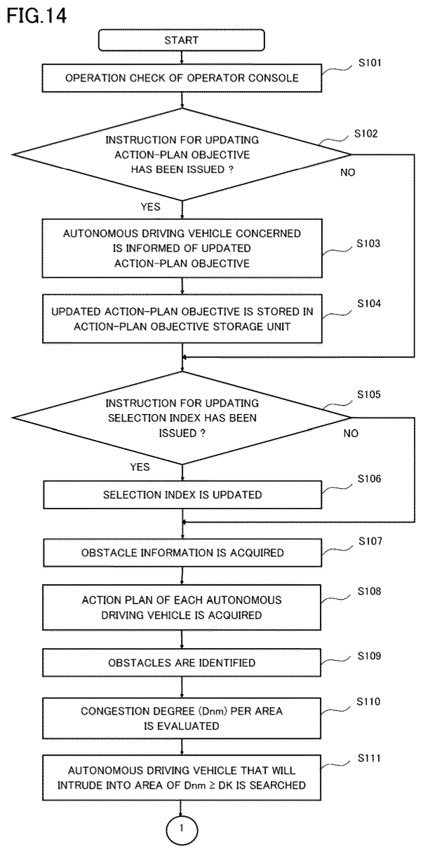

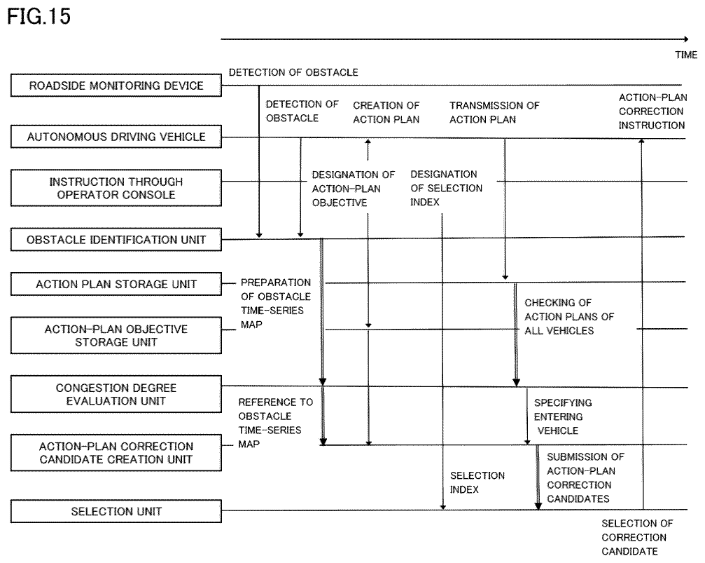

FIG. 14 is a first flowchart showing processing of the vehicle supervision device 100 according to Embodiment 3. The flow subsequent to FIG. 14 is the same as in the flowchart shown in FIG. 12. Accordingly, the flowchart shown in FIG. 12 will also be employed as a second flowchart showing processing of the vehicle supervision device 100 according to Embodiment 3.

In the flowchart of FIG. 14 according to Embodiment 3, what differs from the flowchart of FIG. 11 according to Embodiment 2 resides only in that Steps S101 to S106 in FIG. 14 are added prior to Step S107 in FIG. 11. Here, description will be made only on differences from Embodiment 2.

The processing shown in FIG. 14 and shown subsequently in FIG. 12, is executed by the arithmetic processing device in the vehicle supervision device 100. The processing may be executed every fixed period of time (for example, every 1 ms). It is allowed that the processing is not executed every fixed period of time but executed in response to an event, for example, in response to the reception of the obstacle information generated by the obstacle detection units of the autonomous driving control device 200, the auxiliary driving control device 300 and the roadside monitoring device 400, by the communication unit 101 in the vehicle supervision device 100, or in response to the reception of the action plan from the autonomous driving control device 200 by that communication unit.

In Step S101 in FIG. 14, it is checked whether or not the operator console is operated. In Step S102, it is determined whether or not an instruction for updating the action-plan objective has been issued from the operator console. If the instruction for updating the action-plan objective has been issued (judgment is YES), the flow moves to Step S103. If the instruction for updating the action-plan objective has not been issued (judgment is NO), the flow moves to Step S105.

In Step S103, the updated action-plan objective is sent to the autonomous driving control device 200 of a specified autonomous driving vehicle 20. In Step S104, the updated action-plan objective is stored, together with the name (or the number) of the corresponding autonomous driving vehicle 20, in the action-plan objective storage unit 113 of the vehicle supervision device 100.

In Step S105, it is determined whether or not an instruction for updating the selection index has been issued from the operator console. If the instruction for updating the selection index has been issued (judgement is YES), the flow moves to Step S106. If the instruction for updating the selection index has not been issued (judgement is NO), the flow moves to Step S107.

In Step S106, the selection index is updated. Specifically, such an index is updated that is used when the selection unit 112 of the vehicle supervision device 100 selects the optimum correction candidate from among the correction candidates proposed by the action-plan correction candidate creation unit 111.

Processing subsequent to Step S107 is the same as processing of FIG. 11 according to Embodiment 2. In this manner, in FIG. 14, the action-plan objective and the selection index may be updated in a manner depending on the presence/absence of the operation of the operator console.

### <Time Chart Showing Processing of Vehicle Supervision Device>

FIG. 15 is a time chart showing processing of the vehicle supervision device 100 according to Embodiment 3. In FIG. 15, operations to be executed by the respective devices and the respective function blocks in the vehicle supervision device 100 are described on the horizontal lines. In FIG. 15, the direction from left to right shows the stream of time. Along each vertical line, a flow of data is shown by an arrow. In FIG. 15, the manual driving vehicle 30 is omitted from illustration.

First of all, the obstacle information generated by the obstacle detection unit 403 in the roadside monitoring device 400 and the obstacle detection unit 203 in the autonomous driving vehicle 20 is sent to the obstacle identification unit 103 in the vehicle supervision device 100. The information of the respective obstacles identified by the obstacle identification unit 103 is sent as an obstacle time-series map, to the congestion degree evaluation unit 104.

Then, the operator console 114 in the vehicle supervision device 100 is operated to thereby issue an instruction for updating the action-plan objective of a specific autonomous driving vehicle 20. In the vehicle supervision device 100, the updated action-plan objective of the specific autonomous driving vehicle 20 is stored in the action-plan objective storage unit 113, and will be referred to when the action-plan correction candidate creation unit 111 proposes the correction candidates.

At the same time, the instruction for updating the action-plan objective is sent to the corresponding autonomous driving vehicle 20. In that autonomous driving vehicle 20, on the basis of the updated action-plan objective, a new action plan is created by the action plan creation unit 211. Then, the thus-created action plan is transmitted from the corresponding autonomous driving vehicle 20 to the vehicle supervision device 100 and stored in the action plan storage unit 105.

In the vehicle supervision device 100, the updated action-plan objective of the specific autonomous driving vehicle 20 is stored in the action-plan objective storage unit 113, which will be transferred to the action-plan correction candidate creation unit 111 and referred to, when the action-plan correction candidate creation unit 111: proposes the correction candidates.

Further, the operator console 114 in the vehicle supervision device 100 is operated to thereby issue an instruction for updating the selection index. The updated selection index is sent to the selection unit 112 and used at the time of selecting the action-plan correction candidate.

In the congestion degree evaluation unit 104, a congested area is determined from the obstacle information (obstacle time-series map) sent from the obstacle identification unit 103, and then it is determined from the action plans of all autonomous driving vehicles 20 sent from the action plan storage unit 105, whether or not there is the autonomous driving vehicle 20 that is going to enter the congested area.

If there is the autonomous driving vehicle 20 that is going to enter the congested area, the action-plan correction candidate creation unit 111 is caused to create multiple action-plan correction candidates s for the corresponding autonomous driving vehicle 20 and to submit them to the selection unit 112. Using the updated selection index, the selection unit 112 selects the optimum correction candidate from among the action-plan correction candidates. Then, it sends the thus-selected action-plan correction candidate to the corresponding autonomous driving vehicle 20. Upon receiving the action-plan correction candidate, the corresponding autonomous driving vehicle 20 travels automatically on the basis of that correction candidate, and thus can avoid entering the congested area.

In this manner, by the vehicle supervision device 100 and the vehicle supervision system 900 according to Embodiment 3, it is possible to prevent the congestion situation from being deteriorated due to intrusion of an autonomous driving vehicle 20 into the congested area, to thereby make more efficient the logistics utilizing autonomous driving vehicles 20. Further, it is made possible to update the action-plan objective of a specific autonomous driving vehicle 20 and to update the selection index, by operating the operator console 114. This makes it possible to smoothly execute updating the action-plan objective of the autonomous driving vehicle 20 under supervision and updating the selection index, to thereby achieve highly flexible supervision of the vehicles.

In the foregoing, the description has been made on the assumption that the action plan of each of the autonomous driving vehicles 20 is created by the autonomous driving control device 200 of that autonomous driving vehicle 20; however, it is allowed that the action plan of each of the autonomous driving vehicles is created in the vehicle supervision device 100 and the autonomous driving vehicles 20 each execute autonomous driving while correcting the received action plan. If this is the case, the autonomous driving vehicle 20 may transmit the corrected action plan each time it corrects the action plan, to the vehicle supervision device 100, so that the vehicle supervision device 100 constantly stores the latest action plan of the autonomous driving vehicle 20 in the action plan storage unit 105.

In this disclosure, a variety of exemplary embodiments and examples are described; however, every characteristic, configuration or function that is described in one or more embodiments, is not limited to being applied to a specific embodiment, and may be applied alone or in any of various combinations thereof to another embodiment. Accordingly, an infinite number of modified examples that are not exemplified here are supposed within the technical scope disclosed in the present description. For example, such cases shall be included where at least one configuration element is modified; where at least one configuration element is added or omitted; and furthermore, where at least one configuration element is extracted and combined with a configuration element of another embodiment.

Various embodiments disclosed above are summarized in the following appendices.

### (Appendix 1)

A vehicle supervision device, comprising:
a communication unit that communicates externally;
an obstacle identification unit that acquires obstacle information generated by a plurality of externally-provided obstacle detection units, through the communication unit, to thereby individually identify autonomous driving vehicles and obstacles other than these vehicles;
a congestion degree evaluation unit that evaluates a congestion degree per each area on a basis of information identified by the obstacle identification unit; and
a driving instruction unit that determines whether or not there is the autonomous driving vehicle that is going to enter the area evaluated to be congested by the congestion degree evaluation unit, to thereby, when there is the autonomous driving vehicle that is going to enter said area, send to said autonomous driving vehicle, an instruction for causing that vehicle to avoid entering said area, through the communication unit.

### (Appendix 2)

The vehicle supervision device as set forth in Appendix 1, wherein the obstacle identification unit acquires through the communication unit, a part of the obstacle information transmitted from a vehicle provided with the obstacle detection unit generates nearby obstacle information on a basis of an output of an in-vehicle sensor, and a part of the obstacle information transmitted from a roadside monitoring device provided with the obstacle detection unit that generates nearby obstacle information on a basis of an output of a roadside sensor.

### (Appendix 3)

The vehicle supervision device as set forth in Appendix 1 or 2, further comprising:
an action plan storage unit that acquires and stores, through the communication unit, action plans of the respective autonomous driving vehicles that contain information of their traveling routes and estimated transit time points,
wherein the congestion degree evaluation unit evaluates the congestion degree per each area at each time point, on a basis of the information identified by the obstacle identification unit and the action plans of the respective autonomous driving vehicles stored in the action plan storage unit.

### (Appendix 4)

The vehicle supervision device as set forth in Appendix 3, wherein, with respect to the area whose congestion degree at a time point is evaluated to be equal to or more than a predetermined determinative value by the congestion degree evaluation unit, the driving instruction unit determines according to the action plans stored in the action plan storage unit, whether or not there is the autonomous driving vehicle that is going to enter said area at said time point.

### (Appendix 5)

The vehicle supervision device as set forth in Appendix 4, wherein, with respect to the area whose congestion degree at a time point is evaluated to be equal to or more than the predetermined determinative value by the congestion degree evaluation unit, when there is the autonomous driving vehicle that is going to enter said area at said time point, the driving instruction unit sends to said autonomous driving vehicle, an action-plan correction instruction for causing that vehicle to avoid entering said area at said time point, through the communication unit.

### (Appendix 6)

The vehicle supervision device as set forth in Appendix 5, wherein the driving instruction unit has an action-plan correction candidate creation unit that creates action-plan correction candidates for the autonomous driving vehicle and a selection unit that selects an optimum action-plan correction candidate from the action-plan correction candidates, to thereby send to said autonomous driving vehicle, an optimum action-plan correction instruction for causing that vehicle to avoid entering said area at said time point, through the communication unit.

### (Appendix 7)

The vehicle supervision device as set forth in Appendix 6, wherein the selection unit in the driving instruction unit selects, as the optimum action-plan correction candidate, the action-plan correction candidate that makes an action-plan completion time of said autonomous driving vehicle earliest.

### (Appendix 8)

The vehicle supervision device as set forth in Appendix 6, wherein the selection unit in the driving instruction unit selects, as the optimum action-plan correction candidate, the action-plan correction candidate that makes a maximum value of the congestion degrees according action-plan correction candidates smallest.

### (Appendix 9)

The vehicle supervision device as set forth in any one of Appendices 6 to 8, wherein the driving instruction unit has an action-plan objective designation unit that designates an action-plan objective for determining: a departure place, a via place, a destination place and loading/unloading of goods, that are basic elements for creating the action plan of each of the autonomous driving vehicles; and time restrictions on these elements; and
wherein the action-plan correction candidate creation unit creates action-plan correction candidates for said autonomous driving vehicle on a basis of the action-plan objective designated by the action-plan objective designation unit.

### (Appendix 10)

The vehicle supervision device as set forth in any one of Appendices 6 to 9, wherein the driving instruction unit has a selection index designation unit that designates a selection index for selecting one of the action-plan correction candidates for said autonomous driving vehicle; and
wherein the selection unit selects the optimum action-plan correction candidate from among the action-plan correction candidates on a basis of the selection index designated by the selection index designation unit.

### (Appendix 11)

A vehicle supervision system, comprising:
the vehicle supervision device as set forth in any one of Appendices 1 to 10;
an autonomous driving control device that is mounted on each of the autonomous driving vehicles, that has the obstacle detection unit and that communicates with the vehicle supervision device through an in-vehicle communication unit; and
a roadside monitoring device that has the obstacle detection unit and that communicates with the vehicle supervision device through a roadside communication unit.

### (Appendix 12)

The vehicle supervision system as set forth in Appendix 11, further comprising;
an auxiliary driving control device that is mounted on a manual driving vehicle, that has the obstacle detection unit and that communicates with the vehicle supervision device through an in-vehicle communication unit.

What is claimed is:

1. A vehicle supervision device, comprising:
a communicator that communicates externally;
an obstacle identifier that acquires obstacle information generated by a plurality of externally-provided obstacle detectors, through the communicator, to thereby identify autonomous driving vehicles and obstacles other than these vehicles;
a congestion degree evaluator that evaluates a congestion degree per each area on a basis of information identified by the obstacle identifier; and
a driving instructor that determines whether or not there is the autonomous driving vehicle that is going to enter the area evaluated to be congested by the congestion degree evaluator, to thereby, when there is the autonomous driving vehicle that is going to enter said area, send to said autonomous driving vehicle, an instruction for causing that vehicle to avoid entering said area, through the communicator.

2. The vehicle supervision device as set forth in claim 1, wherein the obstacle identifier acquires through the communicator, a part 4 the obstacle information transmitted from a vehicle provided with the obstacle detector that generates nearby obstacle information on a basis of an output of an in-vehicle sensor, and a part of the obstacle information transmitted from a roadside monitoring device provided with the obstacle detector that generates nearby obstacle information on a basis of an output of a roadside sensor.

3. The vehicle supervision device as set forth in claim 1, further comprising:
an action plan storage that acquires and stores, through the communicator, action plans of the respective autonomous driving vehicles that contain information of their traveling routes and estimated transit time points,
wherein the congestion degree evaluator evaluates the congestion degree per each area at each time point, on a basis of the information identified by the obstacle identifier and the action plans of the respective autonomous driving vehicles stored in the action plan storage.

4. The vehicle supervision device as set forth in claim 3, wherein, with respect to the area whose congestion degree at a time point is evaluated to be equal to or more than a predetermined determinative value by the congestion degree evaluator, the driving instructor determines according to the action plans stored in the action plan storage, whether or not there is the autonomous driving vehicle that is going to enter said area at said time point.

5. The vehicle supervision device as set forth in claim 4, wherein, with respect to the area whose congestion degree at a time point is evaluated to be equal to or more than the predetermined determinative value by the congestion degree evaluator, when there is the autonomous driving vehicle that is going to enter said area at said time point, the driving instructor sends to said autonomous driving vehicle, an action-plan correction instruction for causing that vehicle to avoid entering said area at said time point, through the communicator.

6. The vehicle supervision device as set forth in claim 5, wherein the driving instructor has an action-plan correction candidate creator that creates action-plan correction candidates for the autonomous driving vehicle and a selector that selects an optimum action-plan correction candidate from the action-plan correction candidates, to thereby send to said autonomous driving vehicle, an optimum action-plan correction instruction for causing that vehicle to avoid entering said area at said time point, through the communicator.

7. The vehicle supervision device as set forth in claim 6, wherein the selector in the driving instructor selects, as the optimum action-plan correction candidate, the action-plan correction candidate that makes an action-plan completion time of said autonomous driving vehicle earliest.

8. The vehicle supervision device as set forth in claim 6, wherein the selector in the driving instructor selects, as the optimum action-plan correction candidate, the action-plan correction candidate that makes a maximum value of the congestion degrees according to the action-plan correction candidates smallest.

9. The vehicle supervision device as set forth in claim 6, wherein the driving instructor has an action-plan objective designator that designates an action-plan objective for determining: a departure place, a via place, a destination place and loading/unloading of goods, that are basic elements for creating the action plan of each of the autonomous driving vehicles; and time restrictions on these elements; and
wherein the action-plan correction candidate creator creates the action-plan correction candidates for said autonomous driving vehicle on a basis of the action-plan objective designated by the action-plan objective designator.

10. The vehicle supervision device as set forth in claim 6, wherein the driving instructor has a selection index designator that designates a selection index for selecting one of the action-plan correction candidates for said autonomous driving vehicle; and
wherein the selector selects the optimum action-plan correction candidate from among the action-plan correction candidates on a basis of the selection index designated by the selection index designator.

11. A vehicle supervision system, comprising:
the vehicle supervision device as set forth in claim 1;
an autonomous driving controller that is mounted on each of the autonomous driving vehicles, that has the obstacle detector and that communicates with the vehicle supervision device through an in-vehicle communicator; and
a roadside monitoring device that has the obstacle detector and that communicates with the vehicle supervision device through a roadside communicator.

12. The vehicle supervision system as set forth in claim 11, further comprising;
an auxiliary driving controller that is mounted on a manual driving vehicle, that has the obstacle detector and that communicates with the vehicle supervision device through an in-vehicle communicator.
